(19) United States
(12) Patent Application Publication
(10) Pub. No.: US 2026/0087162 A1
(43) Pub. Date: Mar. 26, 2026

(54) CONTENT SNIPPET MANAGEMENT SERVICE FOR A CONTENT COLLABORATION PLATFORM

(71) Applicant: Atlassian Pty Ltd., Sydney (AU)

(72) Inventors: Sahil Seth, Bengaluru (IN); Jitendra Kumar Chaudhary, Bengaluru (IN)

(21) Appl. No.: 18/896,089

(22) Filed: Sep. 25, 2024

(51) Int. Cl. G06F 21/62

(52) U.S. Cl. CPC G06F 21/6218

(57) ABSTRACT

Embodiments described herein relate to a content collaboration platform user interface including a content panel and a navigation panel. The system can cause a selected portion of content and reference to the selected portion of content to be saved in a content collection datastore. The system can display a content element corresponding to the selected portion of content in the navigation panel. In response to a user selection of the content object from the navigation panel, the system can transmit an authentication request including a document identifier corresponding to the selected portion of content and a user identifier corresponding to the particular user account. In response to receiving an authentication response from the authentication system indicating that a requesting particular user account has permission to view the particular electronic document associated with the document identifier, the system can display a captured content interface including the portion of the content.

### TECHNICAL FIELD

Embodiments described herein relate to content collaboration platforms that are used to manage and share digital content, and more particularly to systems and methods for managing, storing, sharing and modifying portions of digital content.

### BACKGROUND

Organizations may compile and manage one or more content collaboration platforms that include information related to the organization's technology infrastructure or other resources. The content collaboration platform can include content generated by various users of the information network, which may be formatted, presented or otherwise hosted in a variety of ways. Each user of the content collaboration platform can generate content items related to a variety of topics. The content collaboration platform can include content generated at many different times. Users of the system typically access content using search functions, page trees, navigation menus or other navigation functions. In some cases, it may be desirable to have systems and methods that can allow users additional organizational tools for accessing and sharing content items on the content network.

### SUMMARY

Embodiments described herein are directed to systems and methods for managing, saving and accessing portions of content. The methods can include causing display of a content collaboration user interface of a frontend application of the content collaboration platform on a client device. The content collaboration user interface can include a content panel operating a content editor configured to receive user-generated content and store the user-generated content as an electronic document in the content collaboration platform, and a navigation panel including a hierarchical element tree. The hierarchical element tree can include a plurality of hierarchically arranged selectable elements, and each respective selectable element being selectable to cause display of respective document content of a respective electronic document. In response to detecting a user input including a selection of a portion of content displayed in the content panel, the methods can include generating a content snippet record including the selected portion of the content and a document identifier of a particular electronic document corresponding to the selected portion of the content. In response to generating the content snippet record, the methods can include causing a snippet object, corresponding to the content snippet record, to be displayed in the navigation panel. In response to detecting a selection of the snippet object by a user of the client device authenticated with respect to a particular user account, the methods can include accessing the document identifier for the particular electronic document and transmitting a permissions request to a permissions system. The permissions request can include the document identifier and a user identifier corresponding to the particular user account. In response to receiving a permissions response from the permissions system indicating that the particular user account has permission to view the particular electronic document, the methods can include causing display of a captured content interface comprising the selected portion of the content stored in the content snippet record.

Embodiments are also directed to systems and methods for managing captured content. The methods can include causing display of a content collaboration user interface of a frontend application of the content collaboration platform on a client device. The content collaboration user interface can include a content panel operating a content editor configured to receive user-generated content and store the user-generated content as an electronic document in the content collaboration platform, and a navigation panel including a hierarchical element tree. The hierarchical element tree can include a plurality of hierarchically arranged selectable elements, and each respective selectable element being selectable to cause display of respective document content of a respective electronic document. In response to detecting a user input including a selection of a portion of content displayed in the content panel, the methods can include generating a content snippet record comprising the selected portion of the content and a document identifier of a particular electronic document corresponding to the selected portion of the content. In response to generating the content snippet record, the methods can include causing a snippet object, corresponding to the content snippet record, to be displayed in the navigation panel. In response to detecting an update to the selected portion of the content at the content editor, the methods can include causing display of a prompt on the client device. The prompt can include an option to update the content snippet record.

Embodiments are further directed to a content collaboration platform backend application operating on one or more servers. The content collaboration platform backend application operably coupled to a frontend application operating on a client device. The content collaboration platform backend application may be configured to display a content collaboration user interface of a frontend application of the content collaboration platform on a client device. The content collaboration user interface can include a content panel operating a content editor configured to receive user-generated content and store the user-generated content as an electronic document in the content collaboration platform, and a navigation panel including a hierarchical element tree. The hierarchical element tree can include a plurality of hierarchically arranged selectable elements, and each respective selectable element being selectable to cause display of respective document content of a respective electronic document. In response to detecting a user input including a selection of a portion of content displayed in the content panel, the content collaboration system backend application can generate a content snippet record including the selected portion of the content and a document identifier of a particular electronic document corresponding to the selected portion of the content. In response to generating the content snippet record, the content collaboration system backend application can cause a snippet object, corresponding to the content snippet record, to be displayed in the navigation panel. In response to detecting a selection of the snippet object by a user of the client device authenticated with respect to a particular user account, the content collaboration system backend application can access the document identifier for the particular electronic document and transmit a permissions request to a permissions system. The permissions request can include the document identifier and a user identifier corresponding to the particular user account. In response to receiving a permissions response from the permissions system indicating that the particular user account has permission to view the particular electronic document, the content collaboration system backend application can cause display of a captured content interface comprising the selected portion of the content stored in the content snippet record.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified diagram of a content collaboration platform.

FIG. 2 depicts an example process for saving, accessing and sharing portions of a content item.

FIG. 3 depicts an example content collaboration platform graphical user interface that can be configured for selecting and saving portions of content from an electronic document or page.

FIG. 4 depicts an example content collaboration platform graphical user interface that can be configured for selecting and saving of portions of content from an electronic document or page.

FIG. 5 depicts an example content collaboration platform graphical user interface for accessing captured portions of content.

FIG. 6 depicts an example content collaboration platform graphical user interface that can be configured for selecting and saving of portions of content.

FIG. 7 depicts an example content collaboration platform graphical user interface that can be configured for selecting and saving of portions of content.

FIG. 8A depicts an example content collaboration platform graphical user interface for accessing captured portions of content.

FIG. 8B depicts an example content collaboration platform graphical user interface including an update panel for updating a content snippet record.

FIG. 9 depicts an example content collaboration platform graphical user interface for accessing captured portions of content.

FIG. 10 shows a sample electrical block diagram of an electronic device.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiment described herein are directed to systems and processes for capturing, saving, managing and sharing portions of content from electronic documents that are managed by a content collaboration platform. The content collaboration platform can be set up to enable various users internal and external to an organization to create, manage, share, and communicate information about various topics. The collaboration platform can organize content using electronic documents (also referred to herein as “document pages” or “content pages”) each of which can include various types of digital content (e.g., text, images, animations, videos, tables and/or other content types). Users can create, edit and share electronic documents with other users of the system. The content collaboration platform can also provide tools to create content and organize electronic pages under different topics, groups, or otherwise share electronic pages with users of the collaboration platform. Additionally or alternatively, a user may be able to post and/or associate their electronic pages with external pages, such as team, group or topic pages. The collaboration platform described herein can host one or more content pages such as documents. The collaboration platform can track the creation, organization, sharing and accessing of these electronic document pages.

Electronic document pages may include a variety of information and/or content types related to a particular topic. In some cases, the systems and methods described herein allow a user to save a portion of the content on a particular document page and access that portion of content using a dedicated interface. For example, the content collaboration platform may include a captured content interface that can be used to organize and display captured portions of content, which may be stored as a content snippet record, as described herein. Accordingly, a user of a system may be able to directly access the portion of content using the dedicated captured content interface as opposed to needing to find the corresponding electronic document page and then finding the particular portion of content within that document page. The captured content interface can be configured to allow a user to save, organize and display multiple different captured content objects from different electronic document pages. In some cases, the system may generate a graphical object (e.g., a snippet object) corresponding to each captured content portion. The graphical object can include a name/title for the captured content portion, a link to the electronic document that contains the captured content and/or other information. Accordingly, the captured content interface can provide a central repository in which various different portions of content can be accessed independently from the corresponding electronic document.

The content collaboration platform can manage user access and sharing of saved content portions. For example, the collaboration platform can manage access to electronic document pages for individual users of a system. User accounts associated with a user may be configured with defined access permissions, which may be used by the system to determine which electronic documents pages, and/or specific content within those pages, can be accessed and/or modified by a particular user account. The content collaboration platform can manage access to saved portions of content based on user account permissions associated with the corresponding electronic document. For example, user accounts that have access permission that allow a user to view a particular electronic document page can also have access permission to view, save and/or otherwise access the saved portions of content using the capture content interface.

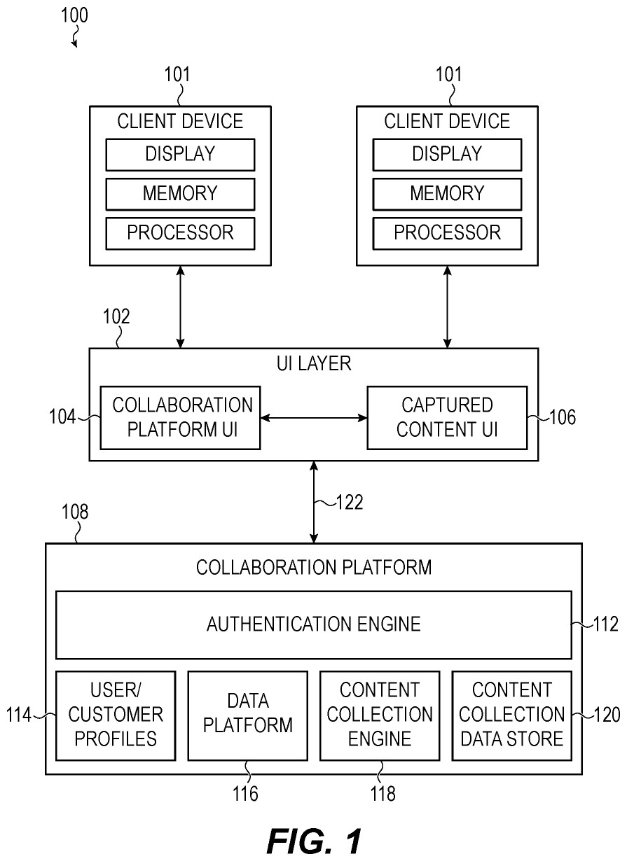

These foregoing and other embodiments are discussed below with reference to FIG. 1-10. The detailed description given herein with respect to these figures is for explanation only and should not be construed as limiting.

FIG. 1 depicts a simplified diagram of a content collaboration platform 100 for managing and sharing content. The collaboration platform 100 can include a user interface (UI) layer 102, a collaboration platform 108 and one or more client devices 101 that access content hosted by the collaboration platform 108 using the UI layer 102. The collaboration platform 100 can also include services such as an authentication engine 112, a profiles service 114, a data platform 116, a content collection engine 118, and a content collection data store 120. These components of the system may be communicably coupled via one or more communication links 122 (one of which is labeled for clarity), which may be implemented as any suitable wired or wireless data transfer connection.

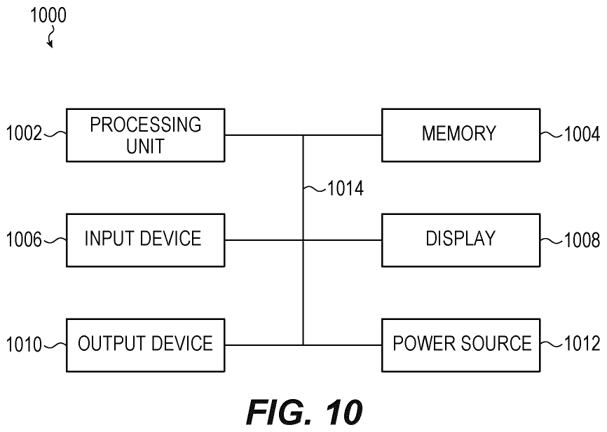

In various embodiments, the collaboration platform 100 is configured to operate within or as a virtual computing environment that is supported by one or more physical servers including one or more hardware resources such as, but not limited to (or required to be) one or more of: a processor; a memory; computer-readable memory or other non-volatile storage; networking connection; and the like, such as those in the electrical block diagram 1000 described with reference to FIG. 10. It may be appreciated that although these functional elements are identified as separate and distinct units (e.g., servers) they can each include allocations of physical or virtual resources, such as one or more processors, memory, and/or communication modules (e.g., network connections and the like). The collaboration platform 100 can leverage such resources to instantiate a number of discrete subservices or purpose-configured modules, containers, or virtual machines each configured to perform, coordinate, serve, or otherwise provide one or more services, functions, or operations of the collaboration platform 100, such as the UI layer 102, the collaboration platform 108, and so on. The collaboration platform 108 may be referred to herein as application platforms or simply platforms, which can reside on the same host server, or in other implementations, they may reside or be provided by a separate or discrete server.

The collaboration platform 100 can be implemented as a content platform that provides a system for various users internal and external to an organization to create, manage, share, and communicate about various topics. In some cases, the collaboration platform 100 allows users to create, modify, comment on or otherwise share information through document pages that include text, pictures, videos or other suitable types of content. Users of the collaboration platform 100 can create pages on various topics, share or otherwise publish their pages for other users to view. In some embodiments, other users, may be able to comment on modify or recommend modifications to a page, and/or link to other content hosted by the collaboration platform or hosted by a system external to the collaboration platform 100.

In other cases, the collaboration platform 100 can be implemented and/or integrated with other computer services or platforms to generate automations for tasks performed by these services or platforms. For example, the collaboration platform 100 can be implemented as part of a code management system, an issue tracking system, email management systems, content feeds, chat systems, or any other suitable system.

The UI layer 102 can include a collaboration platform UI 104 that manages user interactions with the collaboration platform 100, which can include interactions such as creating, viewing, and modifying content that is hosted by the collaboration platform 100. The collaboration platform UI 104 can interface with one or more client devices to display graphical user interfaces of the collaboration platform 100 on various client devices. The UI layer 102 can receive and process user inputs from a client device, communicate with other portions of the collaboration platform such as the collaboration platform 108, and/or other services, and update the client device accordingly. The UI layer 102 can also include a captured content UI 106 that can enable a user to capture and share portions of content hosted by the collaboration platform 100.

The collaboration platform UI 104 may receive or access content items, including user-generated documents, blog posts, calendar entries, or other renderable content, and render the content items in a content panel of a graphical user interface of the content collaboration system 100. The collaboration platform UI 104 may be configured to process content that is formatted in a platform-specific structured data format. For example, the collaboration platform UI 104 and/or the capture content UI 106 may receive or retrieve a document or other content item that is formatted in the platform-specific structured data format, and generate, using the platform-specific structured data format, an output that can be rendered in the content panel of a graphical user interface (GUI) of the content collaboration system 100. The collaboration platform UI 104 and/or the capture content UI 106 may ultimately provide the output to a browser or other application of a client device 101 (via application services or other service of the content collaboration system 100) to cause the content of the document to be displayed to a user.

The authentication engine 112 can authenticate a user of a client device 101, which can enable actions a given user may perform with different resources, documents or other information of the collaboration platform 100. The authentication engine 112 can be used to manage user access to documents such as various spaces and/or electronic document pages. For example, a user may be allowed to create, edit, comment and structure documents associated with their own content space, but may only be able to read and comment on documents associated, created, and/or managed by other users. In some cases, the authentication engine 112 manages different permissions for different users. For example, some users may be assigned administrator privileges, which may give them more access to documents, such as the ability to edit, delete, structure/organize, format, or otherwise manipulate documents for other users of the system. For example, a permissions profile of an authenticated user (e.g., a role or other user profile data) may be evaluated with respect to permissions for a particular content item like an electronic document. A user having a permissions profile that is consistent with the permissions of a content item may be permitted to view, edit, or perform other actions with respect to the content item. The authentication engine 112 may be configured to authenticate a user of a client device 101 in response to successfully authenticating or verifying user credentials, which may be received via the UI layer 102 or may be received from another trusted system or service that may manage user credentials and authentication for a variety of software platforms. The user credentials may include a name and password, authentication token, or other data that can be used to verify and authenticate a system user.

The profiles service 114 can include information about users of the collaboration platform 100. The profiles service 114 can identify a customer, such as an organization that utilizes the collaboration platform 100 and provide the collaboration platform 100 for members of the organization. The profiles service 114 can also include profile information for members of the organization such as usernames, authentication credentials, email addresses, team associations, organizational roles, and so on. The profiles service 114 may store and/or associate a permissions profile for each user account, which can be accessed by the authentication engine 112. Additionally or alternatively, the profiles service 114 may store permissions profiles for content managed by the collaboration platform 100. The authentication engine 112 may access the permissions profiles for content managed by the collaboration platform to evaluate whether a permissions profile for a specific user account grants access to a particular content item.

The data platform 116 can enable storing and processing of data that is generated from user interactions with the collaboration platform 100. The data platform 116 can continuously collect data from UI layer 102, the collaboration platform 108, and/or other services or internal and/or external data sources. The data platform 116 enables machine learning on the collected data sets, enables data mining pipelines, or otherwise allows processing of user interaction data with the collaboration platform 100. In some embodiments, the data platform 116 may be used to generate recommendations and/or automations that are presented to users interacting with the collaboration platform 100 as described herein. In some embodiments, the data platform 116 manages the structure of documents hosted by the collaboration platform, which can affect how the corresponding graphical objects are displayed. The data platform 116 can also manage storage and moving documents between different types of storage.

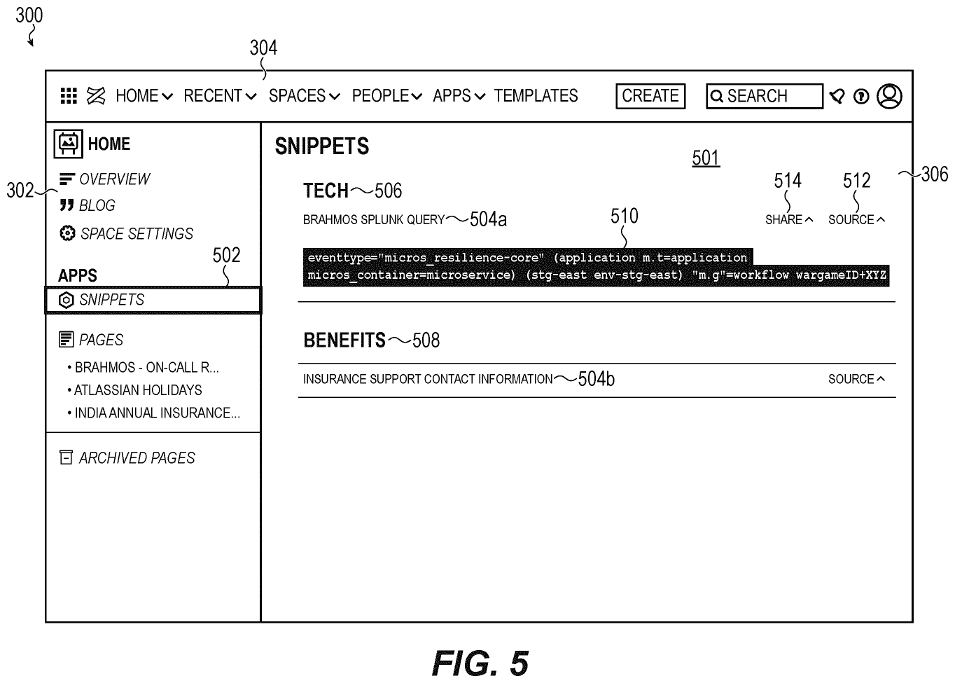

The content collection engine 118 can be configured to enable selection and generation of content snippet records and/or the corresponding snippet objects as described herein. The content collection engine 118 may be configured to facilitate selection of a portion of content from the content collaboration system (e.g., an electronic document page), and create a new data record (e.g., content snippet record) and renderable content therefrom. After processing the selected content from the content source (e.g., electronic document page) using a processing engine and producing renderable content formatted in accordance with the platform-specific structured data format, the content collaboration system 100 may cause the renderable content to be displayed in the content panel. FIG. 5 illustrates the GUI 300 while the renderable content generated by the content processing engine is displayed in the content panel 306. The renderable content may appear in a captured content interface 501 in the content panel 306, and may include a title, a content element (e.g., the captured portion of content), and a link or reference to the content source. These are merely examples of the content that may be saved from a content source and into a renderable object. It will be understood that the content object shown in the figures corresponds to the rendered or displayed content of an underlying data record (e.g., content snippet record). The data record may be a data structure that is formatted in the platform-specific structured data format, which includes content formatted in the platform-specific data structure, and/or includes instructions and/or programmatic elements (and any other associated data) that causes renderable content formatted in the platform-specific structured data format to be produced.

The content data record (e.g., the content snippet record) may be saved to or otherwise processed to produce renderable content (in the platform-specific structured data format) that is stored at the content collection data store 120 and managed in a manner similar to other documents in the content collaboration system 100. Thus, for example, a content processing engine may extract data from the stored content data record, and generate the corresponding data object (e.g., snippet object).

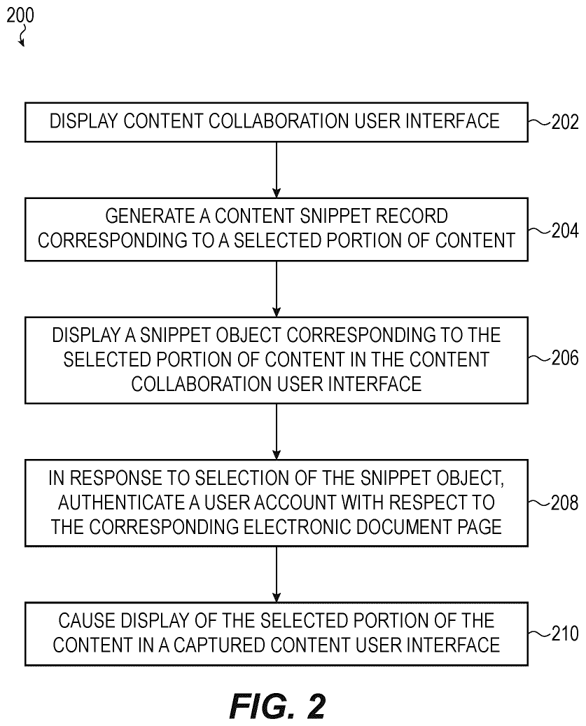

FIG. 2 depicts an example process 200 for saving, accessing and sharing portions of a content item. The process 200 can be performed by the systems described herein including the content collaboration platform 100.

At operation 202, the process 200 includes displaying a content collaboration user interface. The content collaboration interface can be an example of the content collaboration interfaces described herein, and includes a navigation panel and a content panel.

The navigation panel can include items that may be selected in order to cause display of other user-generated content at the content panel. Specifically, the navigation panel includes an overview element that is selectable to cause display of space-overview content in the content panel, and a settings element that can be used to access settings associated with the current page being viewed and/or the document space. In some cases, display of the navigation panel may be suppressed or hidden using a control provided in the graphical user interface. Additionally or alternatively, the navigation panel may be resized or slid all the way to the side of the graphical user interface in order to hide or suppress display of the navigation panel.

The content panel may display the contents of a selected document or other content item and may allow a user to edit the selected document or content item (e.g., to add, change, or remove content). In general, when an authenticated user has edit permissions with respect to the displayed content and the graphical user interface is in an edit mode (rather than a view mode), the content panel may operate as a content editor and allow the user to directly add, edit, modify, or otherwise interact with the content of the document or content item. When a user does not have edit permissions, or when the content panel is otherwise in a view mode, rather than an edit mode, the document or content item may be displayed in a view-only mode, or with only limited ability to add, edit, or otherwise modify the content.

At operation 204, the process 200 includes generating a content snippet record corresponding to a selected portion of content. The content snippet record can be generated in response to a user input to a selectable option (e.g., selectable element 312) associated with a selection of a portion of content displayed within an electronic document page. In some cases, the collaboration platform can be configured with content capture tools that allow a user to select a portion of content and save the selected portion of content in a content snippet record. The content capture tools may be displayed in response to a specific action, such as user inputs to the interface (e.g., selection of portion of content, cursor hover, right click, selection of a particular graphical interface element, and so on). The capture tools may display an option to save the selected portion of content as a snippet record. Additionally, the capture tools can include options to assign a title to the snippet record, associate the snippet record with a particular category, and/or assign other parameters to the snippet record.

The snippet record can include the selected portion of content, which may be saved as part of the snippet record for later display. For example, the content collaboration platform may access the snippet record and display the saved portion of content in a captured content interface, as described herein. The snippet record may include additional information. For example, the snippet record may include information associated with the selected portion of content such as a document identifier of the particular electronic document from which the portion of content was selected. In some cases, the snippet record can include location information for the selected portion of content, which may be used to later identify and/or access the electronic document and display or otherwise indicate the selected portion of content within the electronic document. The location information can include the document identifier along with a line number (or line numbers) of where the selected portion of content is located within the electronic document.

In some cases, the snippet record can include additional data such as a user identifier of a user who selected the content and generated the snippet record. The snippet record can also include time and data information, which can indicate when the content was selected and the record was generated.

In some cases, information stored in the snippet record can be used to update a snippet record based on changes to a corresponding electronic document page, and/or update an electronic document page based on changes to a snippet record, as described herein. For example, the document identification stored in a snippet object can be used to check corresponding electronic documents for updates and prompt a user to update the snippet object in accordance with updates made to the relevant portion of the electronic document (e.g., to the captured content portion of the electronic document). Additionally or alternatively, changes made to a snippet can be propagated to the corresponding document using the document identification to update or prompt a user to update an electronic document in response to changes to a snippet object. In some cases, the system may generate and update a snippet identification and document identification registry, which associates snippet records with electronic documents and vice versa. The registry can be used to identify a corresponding electronic document and content location and/or a snippet to cross-update the electronic document or snippet in response to changes to either the snippet record or electronic document page.

At operation 206, the process 200 includes displaying a snippet object corresponding to a selected portion of content in the content collaboration user interface. In some cases, in response to generating a snippet record, the collaboration platform can generate a snippet object that corresponds to the snippet record and is used to access the captured content and/or information about the captured content. For example, the snippet object can be displayed in one or more user interfaces and selection (or other interaction) can cause the collaboration platform to display the captured portion of content and/or other information associated with the content, as described herein.

At operation 208, the process 200 includes authenticating a user account with respect to an electronic document corresponding to the content snippet record in response to a selection of the respective snippet object. As described herein, the collaboration system can mange access to electronic documents based on permissions associated with each user account. For example, a user account may be assigned a particular role, to one or more teams and/or assigned a particular access level which may be used to determine whether a user is authorized to view a particular electronic document and/or perform other operations with respect to the particular electronic document (e.g., view, edit, share, and so on). In response to attempting to access an electronic document, the collaboration platform may access the user account information to determine if their role or other permissions allow access to the particular electronic document. For example, the collaboration system may submit a request to an authentication system (as referred to herein as a “permissions system”) which may use the user role to determine whether access is allowed and return a response.

Access to an electronic document that corresponds to a particular snippet record can be used to determine whether a particular user account is authorized to view or otherwise access the content of the snippet record. For example, if a user account has access permissions to view the electronic document, it can also be assumed that the user account has access permissions to view particular content (e.g., the selected content saved in a snippet record) within the electronic document. Accordingly, a user account's access permissions to a particular electronic document can be used as a proxy for access to a snippet record that includes content captured from the particular electronic document.

In some cases, the snippet records can be managed using a dedicated permission scheme, for example, that is independent from the permission scheme for the corresponding electronic document pages. For example, the collaboration platform can be configured to define a snippet record content type or class of content, which has its own permissions and may be determined in accordance with a user's snippet collection permissions setting. For example, a user generating a snippet record may define permissions for the corresponding snippet record, as described herein. In some cases, sharing a snippet record with users (e.g., at generation of the record, or at a later time) may automatically define/modify the permissions of the shared snippet to include the shared user(s), user role, group, which can persist with the snippet record.

If the collaboration platform determines that a user account has access permission to an electronic document, then the collaboration platform can cause the content saved in a snippet object to be displayed on a corresponding user device. If the collaboration platform determines that a user account does not have access permission for the electronic document, then the collaboration platform may suppress display of the content saved in the snippet object. In some cases, suppressing display may include displaying some information related to the snippet record and not displaying other information. For example, when display of a snippet object is suppressed, the title or other information can be displayed and the content is not displayed.

At operation 210, the process 200 includes causing display of the selected portion of content on a captured content user interface. In response to determining that a particular user account has access permission to view a corresponding electronic document, the collaboration system can display information from the snippet record. For example, in response to a user selecting the snippet object and authenticating the user account, the collaboration platform may display the captured portion of content in a captured content user interface, as described herein.

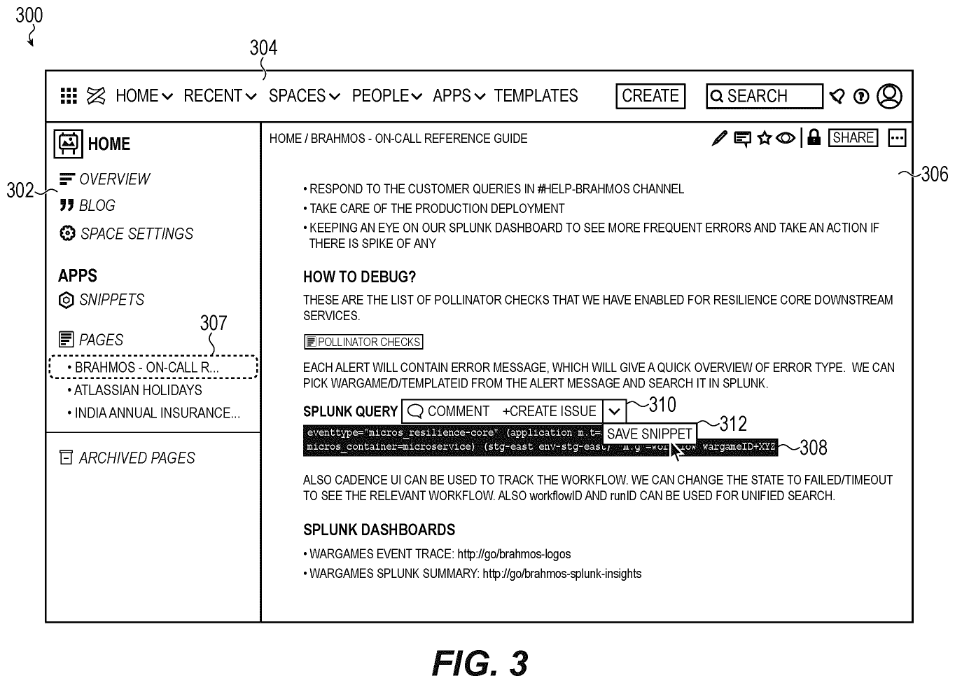

FIG. 3 Depicts an example content collaboration platform graphical user interface 300 that can be configured for selection and saving portions of content from an electronic document page. The interface 300 can be generated using the systems and methods described herein, including content collaboration platform 100.

The graphical user interface 300 can be provided by a frontend or client application and may operate in one of a number of different modes. In a first mode, a user may create, edit, or modify an electronic document, page, or electronic content. This mode or state of the graphical user interface may be referred to as an editor user interface, content-edit user interface, a page-edit user interface, or document-edit user interface. In a second or other mode, the user may view, search, comment on, or share the electronic document, page, or electronic content.

This mode or state of the graphical user interface may be referred to as a viewer user interface, content-view user interface, a page-view user interface, or document-view user interface. The graphical user interface may be implemented in a web browser client application using HTML, JavaScript, or other web-enabled protocol.

The graphical user interface 300 may have various partitions/sections displaying different content. For example, the graphical user interface 300 may include a navigation panel 302, a toolbar 304, and a content panel 306.

The navigation panel 302 may include a page tree, which may be associated with a particular document space or content space. The page tree includes objects, which may be selectable to cause display of a corresponding page or document. Objects may also be referred to herein as selectable elements. Each object shown in the navigation panel 302 may be displayed according to its respective relationship to the current electronic document, page, or electronic content being displayed. Further, each object displayed in the page tree may be selectable. In response to a user selection of a respective object of the page tree, content of the respective page or document may be displayed in the content panel 306.

In some cases, the content collaboration platform may be configured with a default permissions scheme for pages/electronic documents displayed in the page tree. For example, pages/electronic document elements may be displayed in the page tree for a particular user in response to determining that a user has permissions to view the respective pages in the content panel 306. In some cases, the platform may display page tree elements to indicate permissions, for example page tree elements that a user does not have permission to access may be grayed out or displayed using some other visual indictor, which indicates that the user does not have permission to view the content of the corresponding page/electronic document. The viewing of snippet objects in the page tree may be managed differently from the electronic documents, for example, titles for snippet objects may be displayed in the captured content interface and permissions may be evaluated in response to displaying the captured content interface or selection of a particular snippet object, as described herein.

A selectable object 307 in the navigation panel 302 may correspond to a user-generated document, a document that is generated by a source page generation service (and includes renderable content produced by a content processing engine), or a data structure that causes a remote source page generation service to produce renderable content from a content item of an external platform. In some cases, the selectable objects themselves do not indicate which type of document or data structure it corresponds to, while in other cases, the selectable objects include a graphical, textual, or other indicator to indicate the type and/or source of a document (e.g., an icon may indicate whether the document is a native document or generated from an external platform). As described above, selectable objects may be manipulatable in the page tree in the same manner, regardless of the source of the document. Thus, a selectable object that corresponds to a document produced by the remote source page generation service may be manipulatable within the tree in the same manner as a native document. The content included in an electronic document corresponds to a selectable object (e.g., selectable object 307) and stored as part of a snippet record can include images, videos, embedded content, smart links (i.e., selectable objects that include extracted metadata from the linked content item), linked issues from an issue tracking platform, platform-specific objects and symbols (ADF or other markup objects), tables, graphs, and/or other user generated content.

The content panel 306 may display the contents of a selected document or other content item and may allow a user to edit the selected document or content item (e.g., to add, change, or remove content). In general, when an authenticated user has edit permissions with respect to the displayed content and the graphical user interface is in an edit mode (rather than a view mode), the content panel 306 may operate as a content editor and allow the user to directly add, edit, modify, or otherwise interact with the content of the document or content item. When a user does not have edit permissions, or when the content panel 306 is otherwise in a view mode, rather than an edit mode, the document or content item may be displayed in a view-only mode, or with only limited ability to add, edit, or otherwise modify the content.

The page toolbar 304 may provide, to a user, various control options, including but not limited to, set or configure various restrictions for the electronic document, page, or electronic content that the user is creating/editing, and/or to view or review recently accessed electronic documents. The page toolbar 304 may also include a search or query space for the user to enter one or more keywords to perform searches for electronic documents, pages, or electronic content that may be related to the one or more keywords entered by the user. The page toolbar 304 may also include options for selecting a different document space, viewing recently viewed documents or pages, viewing people associated with the system or respective content, navigating or launching other applications, or viewing other aspects of the system. The page toolbar 304 may include a content create element for initiating the creation of content items in the content collaboration platform.

In the example shown in FIG. 3, the selectable object 307, an electronic document page in this example, is selected, and the content associated with the selectable object 307 is displayed in the content panel 306. In response to detecting selection of a portion of content 308, the content collaboration system can initiate one or more processes for generating a content snippet record and displaying a corresponding snippet object in the interface 300. For example, in response to detecting selection of the portion of content 308, the system may display options menu 310. In some, cases, the system may display options menu 310 in response to a user input highlighting the portion of content 308, a right click (or similar input to the portion of content 308), or other suitable input, and/or a combination thereof. The options menu 310 can include a selectable element 312 for generating a snippet record for the selected portion of content 308. In response to detecting an input to the selectable element 312, the system can cause the generation of the snippet record, which may be stored by the content collaboration system (e.g., at the content collection data store 120). In other cases, the generation of the snippet record can be in response to other input, such as a selectable element displayed in toolbar 304, a keyboard shortcut, and so on.

The content snippet record can include a copy of the selected portion of content 308 from the electronic document page. For example, the snippet record may include a plain text and/or formatted version of text from the selected portion of content 308. Additionally the snippet record can include location data indicating a location of the selected portion of the content within the particular electronic document. For example, the snippet record may include a document identifier and a location identifier (e.g., line number(s)) corresponding to the selected portion of content 308. The snippet record can include other data related to the capture event, such as a user account identifier associated with a user account that is causing the snippet record to be generated. In some cases, the snippet record may include time and date data. The snippet record may include other data related to the electronic document and/or the portion of content 308. For example, the snippet record may include keywords or classifiers that are used to organize or identify a type of content associated with the electronic document.

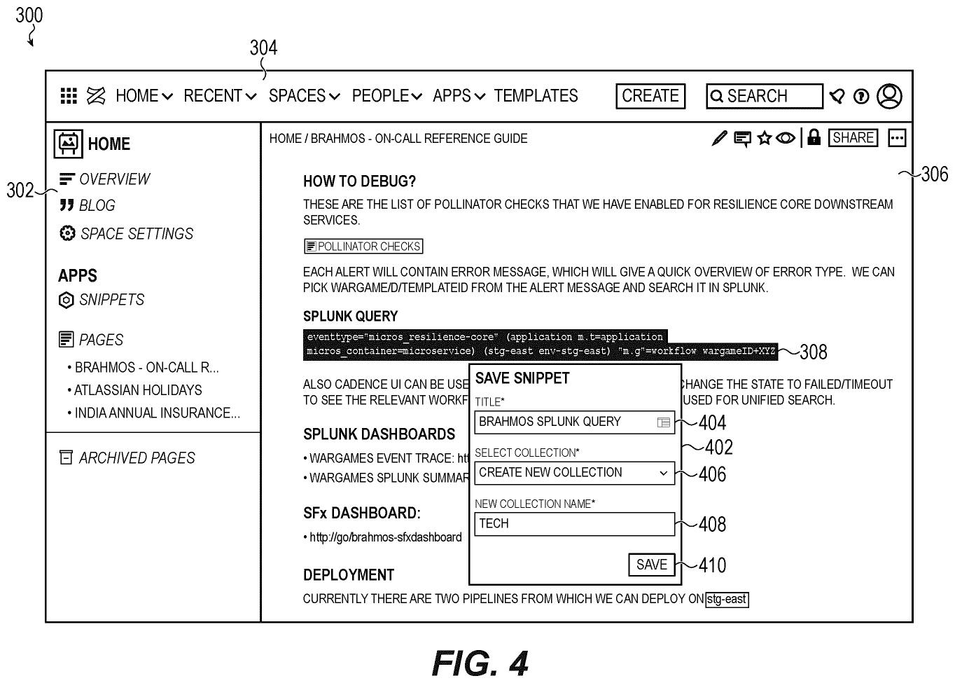

FIG. 4 depicts an example of the content collaboration platform graphical user interface 300 including content capture tool 402 that can be used for generating a content snippet record. The content capture tool 402 can be configured to receive user inputs and/or define other parameters that are associated with the captured portion of content and saved as part of the snippet record. For example, the capture tool 402, which may also be referred to herein as a “snippet panel” can include a first input area 404 configured to assign a title to the content snippet record. The first input area can be configured to receive text input (or other input) that defines a title for the snippet record. In some cases, the title may be displayed as part of the snippet object and used to uniquely identify a particular snippet record and corresponding portion of content 308.

The content capture tool 402 can include a second input area 406 configured to receive input and assign a category to the content snippet record. In some cases, the content capture tool 402 can include a third input area 408 that allows a user to select from a set of pre-defined categories. The category may be used to organize snippet objects and the corresponding captured content items in groups for display at the collaboration platform. For example, snippet records may each be associated with a category and the collaboration platform may display a corresponding snippet object in accordance with the title and category, as described herein.

The content capture tool 402 can include a selectable element 410 for generating the snippet record and corresponding snippet object. For example, in response to detecting an input to the selectable element 410, the system can cause the snippet record to be stored (e.g., at the content collection data store 120) and cause a snippet object for the snipped record to be displayed in the user interface.

In some cases, the content capture tool 402 can include a dynamic input field, which may accept inputs that can be configured to define various parameters associated with the snippet record. For example, the dynamic input field can be configured to define permissions sections for the snippet record, which can define particular users, groups, and/or permission levels that define a permissions access scheme for the snippet record. In other cases, the dynamic input field can be configured to define a user or group of users for sharing the resulting snippet record. For example, the creating user may select a user or group of users and upon creation of the snippet record, the collaboration platform may share the snippet record with the selected users (e.g., by adding or providing an option to add the corresponding snippet object to each respective user's front end interface (e.g., captured content graphical interface)). In other cases, the dynamic input field may allow a user to make public a snippet record (e.g., no viewing restrictions), and other users may be able to search for, view and/or add the snippet record to their respective captured content interface. In some cases, permissions defined in the dynamic input field may define or override the current permissions for a corresponding document. For example, a particular user may not have access to view the corresponding electronic document, but may be able to view the captured portion of content in the snippet record.

FIG. 5 depicts an example of the content collaboration platform graphical user interface 300 including a captured content interface 501 displayed in the content panel 306. In some cases, the navigation panel 302 can include a captured content object 502 that can be configured to cause display of the captured content interface 501 in the content panel 306. For example, in response to detecting a user input to the captured content object 502, the collaboration platform can display the captured content interface 501 in the content panel.

The captured content interface 501 can include one or more snippet objects 504 that each correspond to a respective snippet record that are associated with a particular user account. For example, the captured content interface 501 can display a first snippet object 504a associated with a first content snippet record, and a second snippet object 504b associated with a second content snippet record. In some cases, the default view for a snippet object 504 may include displaying a title corresponding to the snippet object and selection of a title corresponding to a particular snippet object causes display of the saved portion of the captured content for the respective snippet object (e.g., captured content 510 corresponding to the first snippet object 504a). Additionally or alternatively, the captured content interface 501 can display a link 512 configured to open the particular electronic document within the content panel 306. For example, the link may be configured to access the corresponding electronic document using information stored in the corresponding snippet record. Examples of types of content that can be displayed in an electronic document and snippet object 504 include text, images, videos, embedded content, smart links (i.e., selectable objects that include extracted metadata from the linked content item), linked issues from an issue tracking platform, platform-specific objects and symbols (ADF or other markup objects), tables, graphs, and/or other user generated content.

In some cases, the link is configured to cause display of a visual indicator that indicates the selected portion of the content within the particular electronic document. For example, selection of the link can cause the electronic document to be displayed in the content panel 306 and cause the portion of the electronic document corresponding to the captured portion of content to be displayed. In some cases, the collaboration platform may cause the corresponding portion of the content to be highlighted or otherwise emphasized within the electronic document displayed in the content panel 306.

In some cases, the captured content interface 501 can organize the content objects 504 according to a category assigned to each content object 504, a title of the object, usage bases, and so on. For example, the captured content interface 501 shown in FIG. 5 displays the content objects 504 according to an assigned category. The first content object 504a is assigned to a category titled “Tech” (e.g., saved as part of the snippet record) and is displayed under a Tech label 506 and the second content object is assigned to a category titled “Benefits” (e.g. saved as part of the snippet record) and is displayed under a Benefits label 508.

In some cases, as permission for a user is changed/updated with respect to electronic documents managed by the collaboration platform, the system can be configured to update access to the snippet records in accordance with the permission updates. The system may determine a user's permission to view (or otherwise access) a captured content portion that is part of a snippet record in response to a user selection of the corresponding snippet object. For example, a user may initially have access to a particular electronic document and generate or view a corresponding content record. At a later, subsequent time, the user's permissions with respect to the particular electronic document may change and the user account may no longer be able to view or access the electronic document. Accordingly, in response to detecting a selection of the snippet object by a client device authenticated with respect to the particular user account, the system can transmit a permissions request to the permissions system. The permissions request can include the document identifier and a user identifier corresponding to the particular user account. In response to receiving a permissions response from the permissions system indicating that the particular user account does not have permission to view the particular electronic document, the system can suppress display of the selected portion of the content within the captured content interface.

In some cases, a snippet object 504 can include a share option 514 for the selected portion of the content. In response to an input to the share option 514, the content collaboration platform can provide an interface for a user to select other users and /r groups for sharing the captured content. In some cases, the system may manage access to a shared snippet record and/or the corresponding content item for shared users. For example, when a shared user attempts to access the content, the system can transmit a permissions request to the permissions system. The permissions request can include the document identifier (saved as part of the snippet record) and a user identifier corresponding to the shared user account. In response to receiving a permissions response from the permissions system indicating that a second user account has permission to view the particular electronic document corresponding to the snippet record and saved portion of content, the system can display the selected portion of the content on the client device authenticated with respect to the shared user account. In response to receiving a permissions response from the permissions system indicating that a second user account does not have permission to view the particular electronic document, the system can suppress display of the selected portion of the content on the client device authenticated with respect to the shared user account.

In some cases, snippet records and the corresponding snippet object may include content from other platforms integrated with the content collaboration platform. The application platforms may include one or more software applications, and a remote source page generation service. The one or more software applications provide content and content services to users of the system, as described herein. For example, the content collaboration platform may allow users (e.g., via clients) to create, modify, view, and/or otherwise interact with system content, such as user-generated documents. The content collaboration platform may also allow users to create documents using content that is managed by external platforms. As described herein, in such cases, some portion or aspect of the remote content items remains managed by the external platforms, while a locally-managed document (formatted in accordance with a structured data format that is recognized by the content collaboration platform) is managed by the content collaboration platform.

The software applications may include application services and data stores. Application services may facilitate the creation, deletion, management, editing, serving, and/or other services related to the content and/or content items (e.g., documents) associated with that software application and stored in the data store. Data stores may be databases or other data storage resources that store documents, content items, and/or other data related to a software application.

As described herein, the first software application may be a content collaboration system or platform. A second software application may be an issue tracking system that tracks issues via issue tickets, which may be stored in a data store. Issue tickets may include content, such as a user-generated description of an issue, issue status (e.g., closed, open, awaiting review), user assignments, issue ticket urgency, issue ticket age, and the like. In some cases, issue tickets may include user-generated specifications of issues in computer code of software products. The application services of the issue tracking system may facilitate content services related to the issue tickets, including causing user interfaces of the issue tracking system to be displayed to a user on a client, receiving user inputs relating to the creation and/or modification of issue tickets (e.g., changing status, receiving content related to the issue and/or issue resolution, etc.), changes to issue status, changes to user assignments, and the like.

The application platform may include one or more authorization services or authorization servers that are used to authenticate system users (accessing the system through client devices). Once authenticated, the users may be granted access to one or more of the respective software applications, platforms, and system content in accordance with a permissions scheme or profile stored with respect to each registered user account, which may be stored by or managed by a user profile database of the application platform.

In some cases, the content collaboration platform can be configured to generate snippet records and corresponding snippet objects from content managed by other platforms, such as an issue tracking platform. The platforms may share a common editor, which may allow captured content from other platforms (e.g., an issue tracking platform) to be viewed and/or modified at the content collaboration system (e.g., using the captured content graphical user interface). The snippet record may store information, which may allow updates to content managed by another platform (e.g., an issue tracking platform) to generate updates for the snippet object and/or updates to a snippet object to update the corresponding content (e.g., an issue managed by an issue tracking platform), as described herein.

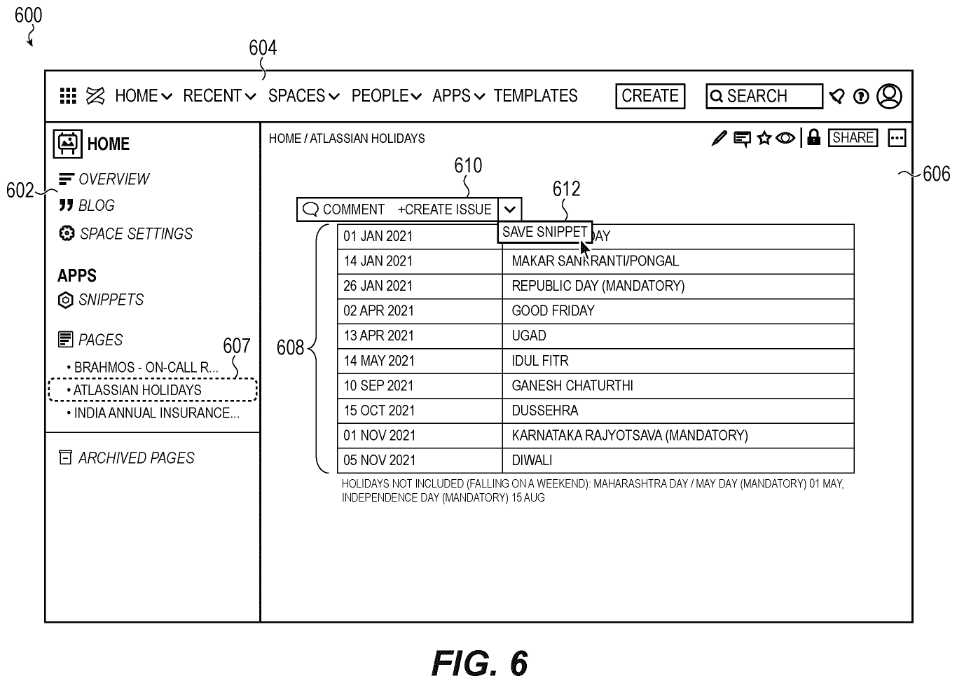

FIG. 6 depicts an example content collaboration platform graphical user interface 600 that can be configured for selection and saving of portions of content from an electronic document page. The interface 600 can be generated using the systems and methods described herein, including content collaboration platform 100.

The graphical user interface 600 can be provided by a frontend or client application and may operate in one of a number of different modes. In a first mode, a user may create, edit or modify an electronic document, page, or electronic content. This mode or state of the graphical user interface may be referred to as an editor user interface, content-edit user interface, a page-edit user interface, or document-edit user interface. In a second or other mode, the user may view, search, comment on, or share the electronic document, page, or electronic content. This mode or state of the graphical user interface may be referred to as a viewer user interface, content-view user interface, a page-view user interface, or document-view user interface. The graphical user interface may be implemented in a web browser client application using HTML, JavaScript, or other web-enabled protocol.

The graphical user interface 600 may have various partitions/sections displaying different content. For example, the graphical user interface 600 may include a navigation panel 602, a toolbar 604, and a content panel 606, which may be examples of similar components described herein (e.g., navigation panel 302, toolbar 304 and content panel 306).

In the example shown in FIG. 6, electronic document page 607 is selected, and the content associated with the electronic document 607 is displayed in the content panel 606. In response to detecting selection of a portion of content 608, the content collaboration system can initiate one or more processes for generating a content snippet record and displaying a correspond snippet object in the interface. For example, in response to detecting selection of the portion of content 608, the system may display options menu 610. In some, cases, the system may display options menu 610 in response to a user input highlighting the portion of content 608, a right click (or similar input to the portion of content 608), or other suitable input, and/or a combination thereof. The options menu 610 can include a selectable element 612 for generating a snippet record for the selected portion of content 608. In response to detecting an input to the selectable element 612, the system can cause the generation of the snippet record, which may be stored by the content collaboration system (e.g., at the content collection data store 120). In other cases, the generation of the snippet record can be in response to other input, such as a selectable element displayed in toolbar 604, a keyboard shortcut, and so on.

The content snippet record can include a copy of the selected portion of content 608 from the electronic document page. For example, the content can include a formatted table, and the snippet record can include both the data stored in the table and the relationship formatting of the data such that the table may be regenerated and displayed as part of a snippet object. In other cases, the snippet record may be configured to capture different types of content such as images, videos, animations, and/or other content types that are supported by the collaboration platform. In some cases, the content record may store a link to the respective content item, for example, a link to an image or video stored at the content collaboration system. Accordingly, the link may be used to access and display the corresponding portion of content within the captured content interface.

Additionally the snippet record can include location data indicating a location of the selected portion of the content within the particular electronic document. For example, the snippet record may include a document identifier and a location identifier (e.g., line number(s)) corresponding to the selected portion of content 608. The snippet record can include other data related to the capture event, such as a user account identifier associated with a user account that is causing the snippet record to be generated. In some cases, the snippet record may include time and date data. The snippet record may include other data related to the electronic document and/or the portion of content 608. For example, the snippet record may include keywords or classifiers that are used to organize or identify a type of content associated with the electronic document.

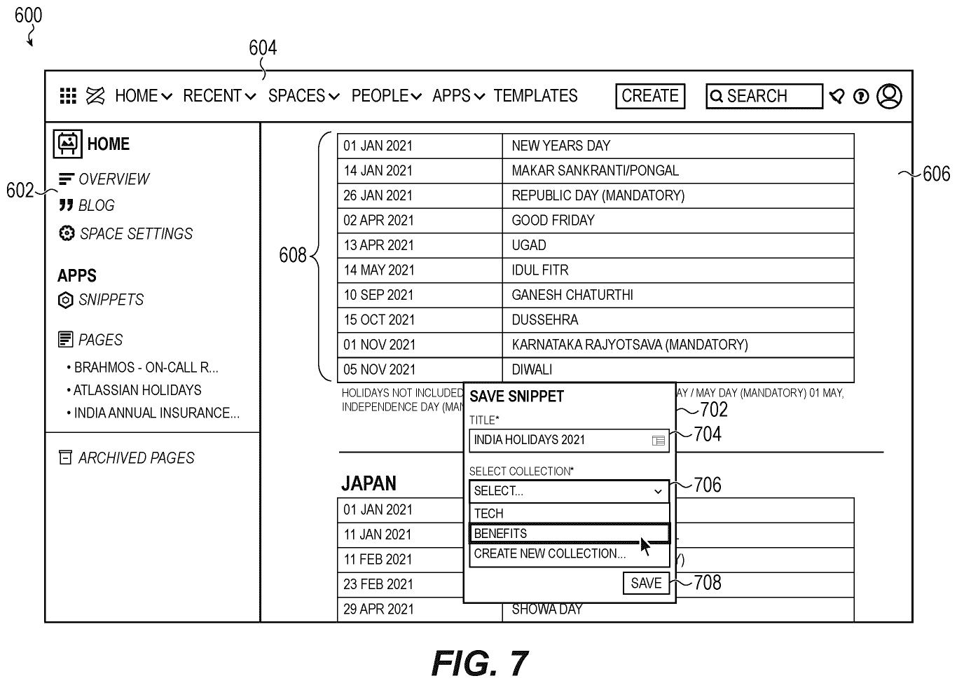

FIG. 7 depicts an example content collaboration platform graphical user interface 600 including a capture tool 702 that can be used for generating a content snippet record. The content capture tool 702 can be configured to receive user inputs and/or define other parameters that are associated with the captured portion of content and saved as part of the snippet record. For example, the capture tool 702, which may also be referred to herein as a “snippet panel” can include a first input area 704 configured to assign a title to the content snippet record. The first input area can be configured to receive text input (or other input) that defines a title for the snippet record. In some cases, the title may be displayed as part of the snippet object and used to uniquely identify a particular snippet record and corresponding portion of content 608.

The capture tool 702 can include a second input area 706 configured to receive input and assign a category to the content snippet record. The second input area 706 allows a user to select from a set of pre-defined categories. The category may be used to organize snippet objects and the corresponding captured content items in groups for display at the collaboration platform. For example, snippet records may each be associated with a category and the collaboration platform may display a corresponding snippet object in accordance with the title and category, as described herein.

The capture tool 702 can include a selectable element 708 for generating the snippet record and corresponding snippet object. For example, in response to detecting an input to the selectable element 708, the system can cause the snippet record to be stored (e.g., at the content collection data store 120) and cause a snippet object for the snipped record to be displayed in the user interface.

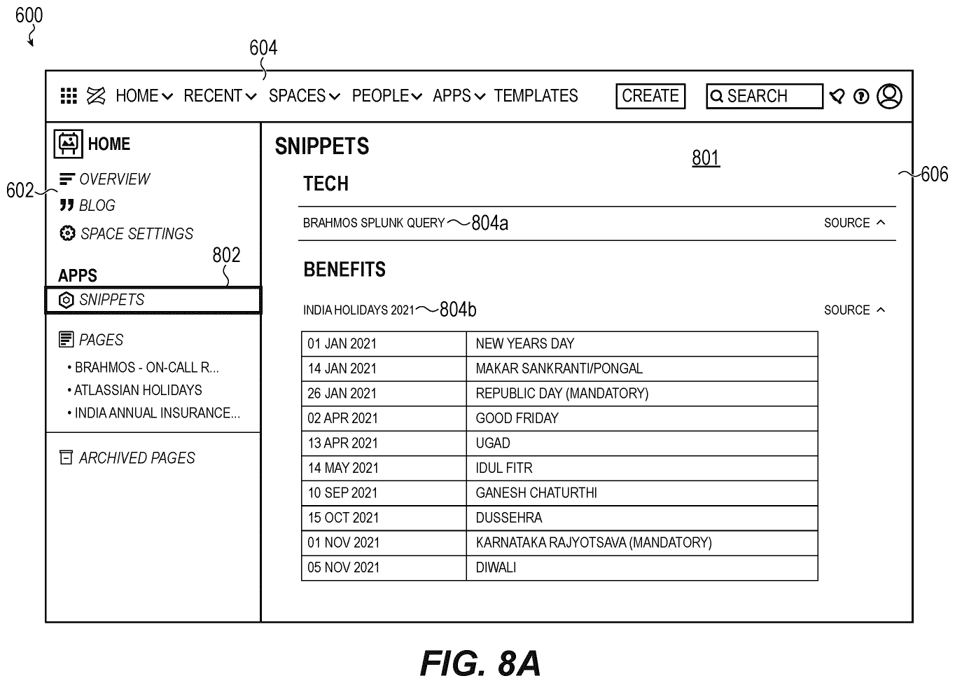

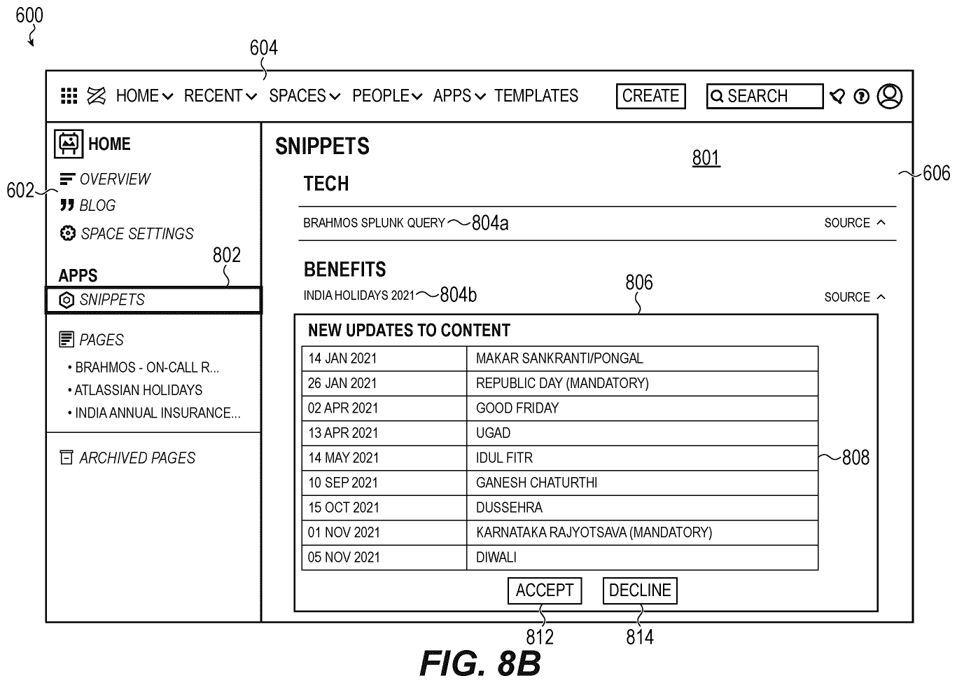

FIG. 8A depicts an example of the content collaboration platform graphical user interface 600 including a captured content interface 801 displayed in the content panel 606. In some cases, the navigation panel 602 can include a captured content object 802 that can be configured to cause display of the captured content interface 801 in the content panel 606. For example, in response to detecting a user input to the captured content object 802, the collaboration platform can display the captured content interface 801 in the content panel 606.

The captured content interface 801 can include one or more snippet objects 804 that each correspond to a respective snippet record that are associated with a particular user account. For example, the captured content interface 801 can display a first snippet object 804a associated with a first content snippet record, and a second snippet object 804b associated with a second content snippet record. In some cases, the default view for a snippet object 804 may include displaying a title corresponding to the snippet object, and selection of a title corresponding to a particular snippet object causes display of the saved portion of the content for the respective snippet object.

FIG. 8B depicts an example of the content collaboration platform graphical user interface 600 including an update panel 806 for updating a content snippet record. The content collaboration platform can be configured to check for updates to content that is saved as part of a content snippet record. For example, a user of the system may update or otherwise modify an electronic document page including content that was saved as part of a content snippet record. In some cases, the collaboration platform may notify a user associated with the content snippet record of the update and provide options for updating the corresponding content snippet record and the snippet object.

In some cases, the content collaboration platform (e.g., the collaboration platform 108) can be configured to check for updates to a content snippet record in response to a request to display the captured content interface and/or a particular snippet object. In other cases, the collaboration platform may check for updates to one or more snippet records periodically, for example in response to launching or displaying the collaboration platform interface on a client device authenticated with respect to a particular user account.

The content collaboration platform may check for updates in a variety of ways. In some cases, the content collaboration platform may use data stored on the content snippet record to determine if the corresponding electronic document page was updated or changed. For example, the content collaboration system may store a log (or other data object) for electronic document pages that records access to the page and/or changes to the page including date/time stamps associated with the access and/or changes. The system may compare a date/time stamp from the content snippet record with a date/time stamp associated with the electronic document page to determine if updates have been made to the electronic document page. If the collaboration platform determines that updates have been made, the collaboration platform may further determine whether the portion of content corresponding to the snippet record was changed, present that changed/updated content to the user, and allow the user to select whether the corresponding snippet record should be updated. For example, the collaboration system may compare content data stored in the snippet record (e.g., text data, meta-data associated with the content, and so on) to the data from the electronic document page to determine if any changes have occurred. In some cases, this can include a text comparison, using metadata to determine if images, video or other media was updated and/or any other suitable processes.

In response to detecting an update at the electronic document page that corresponds to a captured portion of the content saved in the content snippet record, the collaboration platform can cause display of the update panel 806. The updates may be determined on a user account basis and the update panel 806 can be displayed on a client device authenticated with respect to a particular user account. The update panel 806 can include a preview 808 of the updated content, a first selectable element 812 to update the content snippet record in accordance with the updated content, and a second selectable element 814 to decline the update and not modify the current content snippet record.

In some cases, the update panel 806 can indicate the update to the selected portion of the content. For example, the update panel 806 may include formatting that indicates that particular content was added, formatting that indicates particular content was removed, and/or formatting that highlights the changed content. Additionally or alternatively, the update panel 806 may include a summary of the changes, for example, a text based summary that particular content was removed (e.g., a summary stating the first row including the “01 Jan. 2021 NEW YEARS DAY was removed from the table”). Accordingly, a user may be able to select whether they want to preserve the current snippet record or update the snippet record to reflect the changes to the corresponding electronic document page. In some cases, the collaboration system may update the snippet record to include whether an update was accepted or declined. Accordingly, the snippet record may include data that can be used to indicate whether the content saved in the snippet record reflects the current content in the corresponding electronic document page.

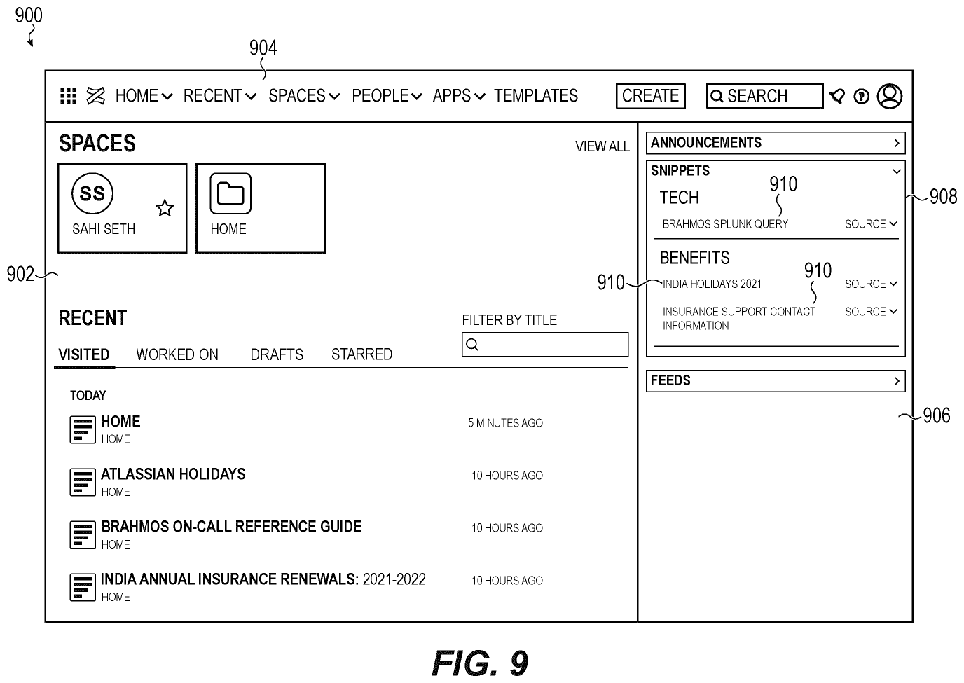

FIG. 9 depicts an example content collaboration platform graphical user interface 900 for accessing captured portions of content. The interface 900 can be generated using the systems and methods described herein, including content collaboration platform 100. The graphical user interface 900 can be provided by a frontend or client application. The graphical user interface 900 may have various partitions/sections displaying different content. For example, the graphical user interface 900 may be an example of a homepage of the content collaboration system and include a first region 902 displaying objects that can be used to access various pages or functions of the content collaboration system, a toolbar 904 which may be an example of the toolbars described herein, and a quick access panel 906.

In some cases, the captured content interface 908 may be viewed and/or accessed from the quick access panel 906. The captured content interface 908 can be an example of the captured content interfaces described herein. The captured content interface 908 can include snippet objects 910 corresponding to snippet records, which may be examples of the snippet objects and snippet records described herein. In some cases, selection of a particular snippet object 910 can cause display of snippet record data in the first region 902 and/or the quick access panel 906. For example, selection of a particular snippet object 910 can cause the corresponding captured content to be displayed in the first region 902. In other examples, selection of a snippet object 910 from the quick access menu 906 can cause the content collaboration interface to display the content collaboration interface including a navigation menu and content panel, as described herein (e.g., with respect to interface 300).

FIG. 10 shows a sample electrical block diagram of an electronic device(s) 1000 that may perform the operations described herein. The electronic device(s) 1000 may in some cases take the form of any of the electronic devices described with reference to FIG. 1-9 including client devices, and/or servers or other computing devices associated with the collaboration platform 100. The electronic device 1000 can include one or more of a processing unit 1002, a memory 1004 or storage device, input device(s) 1006, a display 1008, output device(s) 1010, and a power source 1012. In some cases, various implementations of the electronic device 1000 may lack some or all of these components and/or include additional or alternative components.

The processing unit 1002 can control some or all of the operations of the electronic device 1000. The processing unit 1002 can communicate, either directly or indirectly, with some or all of the components of the electronic device 1000. For example, a system bus or other communication mechanism 1014 can provide communication between the processing unit 1002, the power source 1012, the memory 1004, the input device(s) 1006, and the output device(s) 1010.

The processing unit 1002 can be implemented as any electronic device capable of processing, receiving, or transmitting data or instructions. For example, the processing unit 1002 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 1000 can be controlled by multiple processing units. For example, select components of the electronic device 1000 (e.g., an input device 1006) may be controlled by a first processing unit and other components of the electronic device 1000 (e.g., the display 1008) may be controlled by a second processing unit, where the first and second processing units may or may not be in communication with each other.

The power source 1012 can be implemented with any device capable of providing energy to the electronic device 1000. For example, the power source 1012 may be one or more batteries or rechargeable batteries. Additionally, or alternatively, the power source 1012 can be a power connector or power cord that connects the electronic device 1000 to another power source, such as a wall outlet.

The memory 1004 can store electronic data that can be used by the electronic device 1000. For example, the memory 1004 can store electronic data or content such as, for example, audio and video files, documents and applications, device settings and user preferences, timing signals, control signals, and data structures or databases. The memory 1004 can be configured as any type of memory. By way of example only, the memory 1004 can be implemented as random access memory, read-only memory, flash memory, removable memory, other types of storage elements, or combinations of such devices.

In various embodiments, the display 1008 provides a graphical output, for example, associated with an operating system, user interface, and/or applications of the electronic device 1000 (e.g., a chat user interface, an issue-tracking user interface, an issue-discovery user interface, etc.). In one embodiment, the display 1008 includes one or more sensors and is configured as a touch-sensitive (e.g., single-touch, multi-touch) and/or force-sensitive display to receive inputs from a user. For example, the display 1008 may be integrated with a touch sensor (e.g., a capacitive touch sensor) and/or a force sensor to provide a touch-and/or force-sensitive display. The display 1008 is operably coupled to the processing unit 1002 of the electronic device 1000.

The display 1008 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 1008 is positioned beneath and viewable through a cover that forms at least a portion of an enclosure of the electronic device 1000.

In various embodiments, the input device(s) 1006 may include any suitable components for detecting inputs. Examples of input device(s) 1006 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 1006 may be configured to detect one or more particular types of input and provide a signal (e.g., an input signal) corresponding to the detected input. The signal may be provided, for example, to the processing unit 1002.

As discussed above, in some cases, the input device(s) 1006 include a touch sensor (e.g., a capacitive touch sensor) integrated with the display 1008 to provide a touch-sensitive display. Similarly, in some cases, the input device(s) 1006 include a force sensor (e.g., a capacitive force sensor) integrated with the display 1008 to provide a force-sensitive display.

The output device(s) 1010 may include any suitable components for providing outputs. Examples of output device(s) 1010 include light emitters, audio output devices (e.g., speakers), visual output devices (e.g., lights or displays), tactile output devices (e.g., haptic output devices), communication devices (e.g., wired, or wireless communication devices), and so on, or some combination thereof. Each output device 1010 may be configured to receive one or more signals (e.g., an output signal provided by the processing unit 1002) and provide an output corresponding to the signal.

In some cases, input devices 1006 and output devices 1010 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 1002 may be operably coupled to the input devices 1006 and the output devices 1010. The processing unit 1002 may be adapted to exchange signals with the input devices 1006 and the output devices 1010. For example, the processing unit 1002 may receive an input signal from an input device 1006 that corresponds to an input detected by the input device 1006. The processing unit 1002 may interpret the received input signal to determine whether to provide and/or change one or more outputs in response to the input signal. The processing unit 1002 may then send an output signal to one or more of the output devices 1010, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated by leveraging a discrete virtual machine, which are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed only for legitimate, agreed-upon, and reasonable uses.

What is claimed is:

1. A method comprising a content collaboration platform for managing, saving and accessing portions of content, the method comprising:
causing display of a content collaboration user interface of a frontend application of the content collaboration platform on a client device, the content collaboration user interface comprising:
a content panel operating a content editor configured to receive user-generated content and store the user-generated content as an electronic document in the content collaboration platform; and
a navigation panel including a hierarchical element tree, the hierarchical element tree comprising a plurality of hierarchically arranged selectable elements, each respective selectable element being selectable to cause display of respective document content of a respective electronic document;
in response to detecting a user input including a selection of a portion of content displayed in the content panel, generating a content snippet record comprising the selected portion of content and a document identifier of a particular electronic document corresponding to the selected portion of content; and
in response to generating the content snippet record, causing a snippet object, corresponding to the content snippet record, to be displayed in the navigation panel; and
in response to detecting a selection of the snippet object by a user of the client device authenticated with respect to a particular user account:
accessing the document identifier for the particular electronic document;
transmitting a permissions request to a permissions system, the permissions request comprising the document identifier and a user identifier corresponding to the particular user account; and
in response to receiving a permissions response from the permissions system indicating that the particular user account has permission to view the particular electronic document, causing display of a captured content interface comprising the selected portion of content stored in the content snippet record.

2. The method of claim 1, wherein:
the navigation panel comprises a captured content interface object; and
selection of the captured content interface object causes display of a captured content interface comprising one or more snippet objects in the content panel, the one or more snippet objects comprising the snippet object.

3. The method of claim 2, wherein generating the content snippet record comprises:
causing display of a snippet panel in the content panel, the snippet panel comprising a first input area configured to receive input for assigning a title to the content snippet record and a second input area configured to receive input for assigning a category to the content snippet record; and
the snippet object is displayed in the captured content interface in accordance with an assigned title and an assigned category.

4. The method of claim 2, wherein:
the captured content interface displays a title for each of the one or more snippet objects; and
selection of a title corresponding to a particular snippet object of the one or more snippet objects causes display of the selected portion of content corresponding to the particular snippet object.

5. The method of claim 1, wherein:
the content snippet record comprises location data indicating a location of the selected portion of content within the particular electronic document; and
the snippet object comprises a link configured to cause display of the particular electronic document at the location of the selected portion of content in the content panel.

6. The method of claim 1, wherein:
the snippet object comprises an option to share the selected portion of content;
in response to an input to the option to share the selected portion of content with a second user account:
transmitting the permissions request to the permissions system, the permissions request comprising the document identifier and a second user identifier corresponding to the second user account;
in response to receiving a permissions response from the permissions system indicating that the second user account has permission to view the particular electronic document, causing display of the selected portion of content on the client device authenticated with respect to the second user account; and
in response to receiving a permissions response from the permissions system indicating that the second user account does not have permission to view the particular electronic document, suppressing display of the selected portion of content on the client device authenticated with respect to the second user account.

7. The method of claim 1, further comprising:
in response to detecting a subsequent selection of the snippet object by the user of the client device authenticated with respect to the particular user account, the subsequent selection occurring after the selection of the snippet object:
transmitting a subsequent permissions request to the permissions system, the subsequent permissions request comprising the document identifier and the user identifier corresponding to the particular user account; and
in response to receiving a subsequent permissions response from the permissions system indicating that the particular user account does not have permission to view the particular electronic document, suppressing display of the selected portion of content within the captured content interface.

8. The method of claim 1, further comprising, in response to detecting an update to the selected portion of content at the content editor, causing display of a prompt to the client device associated with the particular user account, the prompt comprising an option to update the content snippet record.

9. A method comprising a content collaboration platform for managing captured content, the method comprising:
causing display of a content collaboration user interface of a frontend application of the content collaboration platform on a client device, the content collaboration user interface comprising:
a content panel operating a content editor configured to receive user-generated content and store the user-generated content as an electronic document in the content collaboration platform; and
a navigation panel including a hierarchical element tree, the hierarchical element tree comprising a plurality of hierarchically arranged selectable elements, each respective selectable element being selectable to cause display of respective document content of a respective electronic document;
in response to detecting a user input including a selection of a portion of content displayed in the content panel, generating a content snippet record comprising the selected portion of content and a document identifier of a particular electronic document corresponding to the selected portion of content; and
in response to generating the content snippet record, causing a snippet object, corresponding to the content snippet record, to be displayed in the navigation panel; and
in response to detecting an update to the selected portion of content at the content editor, causing display of a prompt on the client device, the prompt comprising an option to update the content snippet record.

10. The method of claim 9, wherein causing display of the prompt occurs in response to detecting a user selection of the snippet object by the client device authenticated with respect to a particular user account.

11. The method of claim 9, wherein the prompt comprises:
an indication of the update to the selected portion of content;
a first selectable object configured to cause the selected portion of content to be updated in accordance with the update; and a second selectable object configured to cause the selected portion of content to not be updated.

12. The method of claim 9, further comprising:
causing display of a captured content interface comprising one or more snippet objects including the snippet object;
in response to detecting a selection of the snippet object by the client device authenticated with respect to a particular user account:
transmitting a permissions request to a permissions system, the permissions request comprising the document identifier and a user identifier corresponding to the particular user account; and
in response to receiving a permissions response from the permissions system indicating that the particular user account has permission to view the particular electronic document, causing display of the selected portion of content stored in the content snippet record.

13. The method of claim 12, wherein causing display of the selected portion of content comprises causing display of a link configured to open the particular electronic document within the content panel.

14. The method of claim 13, wherein the link is configured to cause display of a visual indicator that indicates the selected portion of content within the particular electronic document.

15. The method of claim 9, further comprising, in response to detecting a selection of the snippet object by the client device authenticated with respect to a particular user account, causing display of the snippet object within a captured content interface.

16. The method of claim 15, wherein the captured content interface comprises a selectable share object configured to share the content snippet record with another user account of the content collaboration platform.

17. A content collaboration platform backend application operating on one or more servers, the content collaboration platform backend application operably coupled to a frontend application operating on a client device, the content collaboration system backend application configured to:
cause display of a content collaboration user interface of the frontend application of the content collaboration platform on the client device, the content collaboration user interface comprising:
a content panel operating a content editor configured to receive user-generated content and store the user-generated content as an electronic document in the content collaboration platform; and
a navigation panel including a hierarchical element tree, the hierarchical element tree comprising a plurality of hierarchically arranged selectable elements, each respective selectable element being selectable to cause display of respective document content of a respective electronic document;
in response to detecting a user input designating a selection of a portion of content displayed in the content panel, generate a content snippet record comprising the selected portion of content and a document identifier of a particular electronic document corresponding to the selected portion of content; and
in response to generating the content snippet record, cause a snippet object, corresponding to the content snippet record, to be displayed in the navigation panel.

18. The content collaboration platform of 17, wherein the content collaboration system backend application is configured to:
in response to detecting a selection of the snippet object by the client device authenticated with respect to a particular user account:
accesses the document identifier for the particular electronic document;
transmit a permissions request to a permissions system, the permissions request comprising the document identifier and a user identifier corresponding to the particular user account; and
in response to receiving a permissions response from the permissions system indicating that the particular user account has permission to view the particular electronic document, cause display of a captured content interface comprising the selected portion of content stored in the content snippet record.

19. The content collaboration system of claim 17, wherein:
the content snippet record comprises location data indicating a location of the selected portion of content within the particular electronic document; and
the snippet object comprises a link configured to cause display of the particular electronic document at the location of the selected portion of content in the content panel.

20. The content collaboration platform of claim 17, wherein the content collaboration system backend application is configured to, in response to detecting an update to the selected portion of content at the content editor, cause display of a prompt on the client device, the prompt comprising an option to update the content snippet record.
